(19) United States
(12) Patent Application Publication
(10) Pub. No.: US 2021/0360895 A1
(43) Pub. Date: Nov. 25, 2021

(54) No Scatter Litter Box

(71) Applicant: Lance McGregor Ketko, Plano, TX (US)

(72) Inventor: Lance McGregor Ketko, Plano, TX (US)

(21) Appl. No.: 17/326,248

(22) Filed: May 20, 2021

Related U.S. Application Data
(60) Provisional application No. 63/027,823, filed on May 20, 2020.

(51) Int. Cl. A01K 1/01

(52) U.S. Cl. CPC A01K 1/0125

(57) ABSTRACT

A litter box includes a pan, tabs, a first shelf, and a second shelf. The pan includes a bottom panel connected to at least one wall panel that extends outwardly from the pan such that a volume is defined between the bottom panel and the at least one wall. The pan includes a first end and a second end opposite the first end. The tabs are connected to the at least one wall at the first end. The tabs project inwardly into the volume of the pan. The first shelf is disposed adjacent the at least one wall panel at the first end and connected to the tabs. The second shelf is disposed adjacent the at least one wall panel at the first end and connected to the plurality of tabs.

### CROSS REFERENCE TO RELATED APPLICATIONS

This application claims the benefit of U.S. Provisional Application No. 63/027,823, filed May 20, 2020, which is hereby incorporated by reference herein.

### BACKGROUND

A persistent problem with litter boxes is scattering of litter during or after use by an animal, such as a cat. Scattered litter may be unsanitary, unsightly, and/or have an unpleasant odor.

### BRIEF DESCRIPTION OF DRAWINGS

FIG. 1 shows a litter box, in accordance with one or more embodiments.

### DETAILED DESCRIPTION

Specific embodiments of the invention will now be described in detail with reference to the accompanying FIGURE. Like elements in the FIGURE are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

The term “about,” when used with respect to a physical property that may be measured, refers to an engineering tolerance anticipated or determined by an engineer or manufacturing technician of ordinary skill in the art. The exact quantified degree of an engineering tolerance depends on the product being produced and the technical property being measured. For a non-limiting example, two angles may be “about congruent” if the values of the two angles are within ten percent of each other. However, if an engineer determines that the engineering tolerance for a particular product should be tighter, then “about congruent” could be two angles having values that are within one percent of each other. Likewise, engineering tolerances could be loosened in other embodiments, such that “about congruent” angles have values within twenty percent of each other. In any case, the ordinary artisan is capable of assessing what is an acceptable engineering tolerance for a particular product, and thus is capable of assessing how to determine the variance of measurement contemplated by the term “about.”

As used herein, the term “connected to” contemplates at least two meanings. In a first meaning, unless otherwise stated, “connected to” means that component A was, at least at some point, separate from component B, but then was later joined to component B in either a fixed or removably attached arrangement. In a second meaning, unless otherwise stated, “connected to” means that component A could have been integrally formed with component B. Thus, for example, assume a bottom of a pan is “connected to” a wall of the pan. The term “connected to” may be interpreted as the bottom and the wall being separate components that are snapped together, welded, or are otherwise fixedly or removably attached to each other. Additionally, the term “connected to” also may be interpreted as the bottom and the wall being contiguously together as a monocoque body formed by, for example, a molding process. In other words, the bottom and the wall, in being “connected to” each other, could be separate components that are brought together and joined, or may be a single piece of material that is bent at an angle so that the bottom panel and the wall panel are identifiable parts of the single piece of material.

In general, embodiments of the invention relate to a litter box configured to minimize or eliminate the scatter of litter caused by an animal using the litter box. The one or more embodiments include several features which, alone and also in combination, improve the anti-scattering properties of the one or more embodiments relative to known litter boxes.

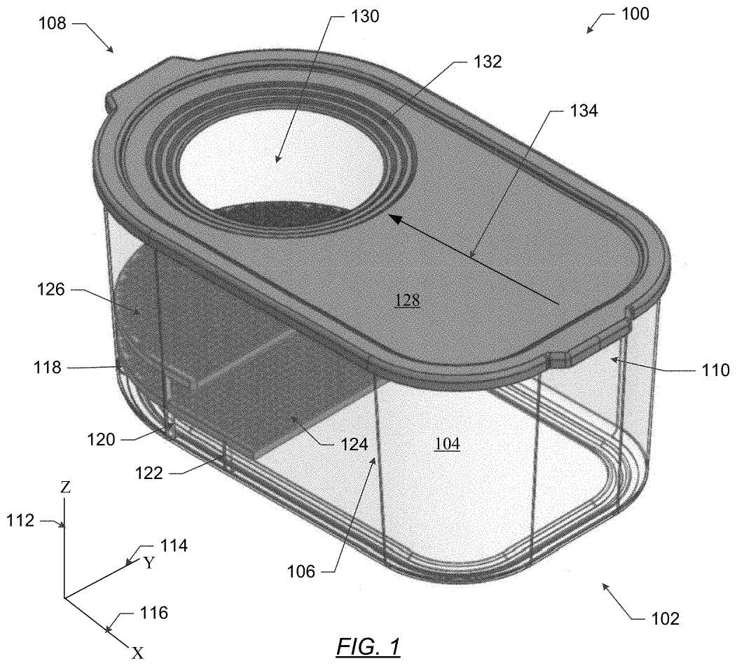

In particular, attention is turned to FIG. 1. FIG. 1 shows a litter box (100). The litter box (100) includes a pan (102) formed of a bottom panel (104) connected to at least one wall panel (106). The wall panel (106) shown in FIG. 1 may be a continuously formed wall integrally formed with the bottom panel (104), such as when the pan (102) is formed by a molding process.

The pan (102) is defined by a first end (108) and a second end (110) that is opposite the first end (108). The pan (102) is also defined by a height, a width, and a length. The height is defined along Z-axis (112). The width is defined along Y-axis (114). The length is defined along X-axis (116). Thus, the term “depth” refers to a distance along the Z-axis (112). Similarly, the term “latitude” refers to a distance along the Y-axis (114), and the term “longitude” refers to a distance along the X-axis (116).

The pan (102) may have a variety of different dimensions. In one embodiment, a length of the pan is at least fifty percent greater than a width of the pan. The elongated configuration that results has utility in reducing the scatter of litter held in the pan, as described further below.

The pan (102) includes one or more tabs, such as first tab (118), second tab (120), and third tab (122), as well as opposing tabs on an opposing wall of the pan (102). The tabs are connected to the wall panel (106) and/or the bottom panel (104). The tabs project inwardly into the volume of the pan. The tabs may have varying heights.

In addition, one or more shelves are disposed inside the pan (102), at one end at of the pan (102). In the example of FIG. 1, two shelves are connected to the wall panel (106) at the first end (108) of the pan (102). In an embodiment, the tabs support the shelves. Tabs of varying heights may be used to create a separation between the shelves.

Thus, for example, the first tab (118) and the third tab (122) support a first shelf (124). Additional tabs may be used to further support the first shelf (124). The first shelf (124) extends inwardly into the volume of the pan (102) from the first end (108) by a first longitudinal distance. The first shelf (124) is also elevated in height by a first distance from the bottom panel (104).

Additionally, the second tab (120) supports the second shelf (126). Additional tabs may be used to further support the second shelf (126). The second shelf (126) extends inwardly into the volume of the pan (102) from the first end (108) by a second longitudinal distance. The second longitudinal distance is less than the first longitudinal distance of the first shelf (124). In other words, the second shelf (126) is shorter than the first shelf (124). The second shelf (126) is also elevated in height by a second distance from the bottom panel (104). The second distance is greater than the first distance. In other words, the second shelf (126) is suspended above the first shelf (124) relative to the direction of the Z-axis (112).

Together, the first shelf (124) and the second shelf (126) form a stair disposed within the pan (102). Litter is disposed in the pan (102) nearer to the second end (110) of the pan. Thus, when an animal is ready to leave the litter box (100), the animal is forced to step onto one or more of the shelves of the stair.

The first shelf (124) and the second shelf (126) may include many perforations disposed in a waffle-like pattern. Thus, when the animal steps onto one or more of the shelves of the stair, litter trapped in the animal's paws is urged to fall from the animal's paws, onto a shelf, through the perforations, and into the pan. The first shelf (124) and the second shelf (126) may be independently installed in the pan (102). Thus, this design allows the end user to choose only one of the first shelf (124) or the second shelf (126) to be placed into the pan (102).

In an embodiment, the first shelf (124) and the second shelf (126) are formed from an inflexible material. A material is considered inflexible, as used herein, when the material is composed of a material of sufficient thickness that the material remains rigid when subjected to an overall pressure of five pounds or less. An example of an inflexible material is polyetheretherketone, though many other materials may be deemed “inflexible” at varying thicknesses.

Additionally, the litter box (100) includes a lid (128). The lid (128) is sized and dimensioned to be removably attachable to the wall panel (106). The lid (128) is formed from a semi-flexible material.

A material is considered semi-flexible, as used herein, when the material deforms when subjected to an overall pressure of two pounds or more applied to one or more portions of the lid (128). An example of a semi-flexible material is polypropylene, though many other materials may be deemed “semi-flexible” at varying thicknesses.

A hole (130) is disposed in the lid (128). The hole (130) is sized and dimensioned to allow an animal to pass through the lid (128). The hole may be circular, but may be a variety of different shapes, including a square, a hemisphere, an ellipse, and a combination of different shapes. Additionally, the lid (128) is disposed a height above the second shelf (126) such that selected species of animal may step from the second shelf (126) and/or the first shelf (124) and exit the hole (130) without jumping. An example of such an animal species is the domestic house cat, whose scientific species name is Felis catus. An example of such a height is an overall pan height of about 13 inches, a pan length of about 30 inches, and a pan width of about 18 inches. The thicknesses of the lid, the walls, and pan may be about 0.1 inches. However, the dimensions may be varied, particularly if the litter box (100) is intended for use by different animal species.

The rim (132) of the hole (130) is defined by a multiply terraced structure. In the example of FIG. 1, three terraces are defined below the upper surface of the lid (128), which effectively forms a fourth terrace. The terraces may, themselves, include sub-terraces. Thus, the appearance of the rim (132) is that of several ridged terraced rings that descend inwardly into the volume of the pan (102). The terraces and the sub-terraces form an overall structure which further urges litter to leave the paws of the animal and then fall back into the volume of the pan (102). The diameters of the three terraces may be about 13, 12, and 11 inches. However, the dimensions may be varied.

As noted above, the lid (128) is made of a semi-flexible material. Thus, when the animal steps out of the hole and onto the surface of the lid (128), the lid (128) bends in response to the weight of the animal. In particular, due to the elongated shape of the litter box (100), a longitudinal crease forms along the direction of the longitudinal arrow (134) shown in FIG. 1. The longitudinal crease forms a depression in the lid (128) which has a greater height at the second end (110) of the pan and which terminates at the rim (132) of the hole (130). Thus, again, any litter that falls onto the lid (128) is urged by the force of gravity to fall back into the volume of the pan (102).

The one or more embodiments described above are not necessarily limited to the example of FIG. 1.

The above embodiments may also be described as follows:

A litter box comprising:

a pan comprising a bottom panel connected to at least one wall panel that extends outwardly from the pan such that a volume is defined between the bottom panel and the at least one wall, the pan comprising a first end and a second end opposite the first end;

a plurality of tabs connected to the at least one wall at the first end, wherein:

the plurality of tabs project inwardly into the volume of the pan;

a first shelf disposed adjacent the at least one wall panel at the first end and connected to the plurality of tabs, wherein:

the first shelf extends inwardly into the volume from the first end by a first distance, and

the first shelf is disposed a first height from the bottom panel; and

a second shelf disposed adjacent the at least one wall panel at the first end and connected to the plurality of tabs, wherein:

the second shelf extends inwardly into the volume from the first end by a second distance that is less than the first distance,

the second shelf is disposed a second height from the bottom panel that is greater than the first height.

A litter box, wherein the first shelf and the second shelf comprise pluralities of perforations arranged in a waffle pattern.

A litter box, wherein a third height, defined between the second shelf and a rim of a hole in a lid connected to the pan, is sized and dimensioned so that an average adult member of species Felis catus can step from the second shelf and through the hole without jumping.

A litter box further comprising:

a lid removably attachable to the pan.

A litter box, wherein the lid comprises a terraced hole disposed at the first end and over the first shelf and the second shelf.

A litter box, wherein the first shelf and the second shelf are removably attached to the plurality of tabs.

A litter box comprising:

a pan comprising a solid bottom panel and at least one solid wall connected to the bottom panel; and

a lid removably connected to the at least one wall of the pan, wherein the lid further comprises a hole disposed in the lid, and wherein the lid further comprises:

a plurality of terraces extending downwardly from an upper surface of the lid.

A litter box, wherein the hole comprises a circular hole and the plurality of terraces comprise terraced rings of sequentially decreasing diameters relative to a center of the hole.

A litter box, wherein the lid comprises a semi-flexible material, wherein a material is the semi-flexible material when the material bends when subjected to a weight of two pounds or greater.

A litter box, wherein a length of the lid and a width of the lid are selected so that when the lid is subject to a weight of two pounds or greater, an about longitudinally directed crease forms in the lid at an angle such that, at a location where the crease intersects the hole, a first height of the location depresses further into a volume defined by the pan than a second height of an opposing end of the pan relative to the hole.

A litter box, wherein the lid is removably attached to a first flange protruding outwardly from the at least one wall at a first end of the pan, and to a second flange protruding outwardly from the at least one wall at a second end of the pan, opposite the first end.

A litter box, wherein a length of the lid is at least fifty percent greater than a width of the lid.

While FIG. 1 shows a configuration of components, other configurations may be used without departing from the scope of the invention. For example, various components may be combined to create a single component. As another example, the functionality performed by a single component may be performed by two or more components.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A litter box comprising:
a pan comprising a bottom panel connected to at least one wall panel that extends outwardly from the pan such that a volume is defined between the bottom panel and the at least one wall, the pan comprising a first end and a second end opposite the first end;
a plurality of tabs connected to the at least one wall at the first end, wherein:
the plurality of tabs project inwardly into the volume of the pan;
a first shelf disposed adjacent the at least one wall panel at the first end and connected to the plurality of tabs, wherein:
the first shelf extends inwardly into the volume from the first end by a first distance, and
the first shelf is disposed a first height from the bottom panel; and
a second shelf disposed adjacent the at least one wall panel at the first end and connected to the plurality of tabs, wherein:
the second shelf extends inwardly into the volume from the first end by a second distance that is less than the first distance,
the second shelf is disposed a second height from the bottom panel that is greater than the first height.

2. The litter box of claim 1, wherein the first shelf and the second shelf comprise pluralities of perforations arranged in a waffle pattern.

3. The litter box of claim 1, wherein a third height, defined between the second shelf and a rim of a hole in a lid connected to the pan, is sized and dimensioned so that an average adult member of species Felis catus can step from the second shelf and through the hole without having to jump out of the box.

4. The litter box of claim 1 further comprising:
a lid removably attachable to the pan.

5. The litter box of claim 4, wherein the lid comprises a terraced hole disposed at the first end and over the first shelf and the second shelf.

6. The litter box of claim 1, wherein the first shelf and the second shelf are removably attached to the plurality of tabs.

7. A litter box comprising:
a pan comprising a solid bottom panel and at least one solid wall connected to the bottom panel; and
a lid removably connected to the at least one wall of the pan, wherein the lid further comprises a hole disposed in the lid, and wherein the lid further comprises:
a plurality of terraces extending downwardly from an upper surface of the lid.

8. The litter box of claim 7, wherein the hole comprises a circular hole and the plurality of terraces comprise terraced rings of sequentially decreasing diameters relative to a center of the hole.

9. The litter box of claim 7, wherein the lid comprises a semi-flexible material, wherein a material is the semi-flexible material when the material bends when subjected to a weight of two pounds or greater.

10. The litter box of claim 9, wherein a length of the lid and a width of the lid are selected so that when the lid is subject to a weight of two pounds or greater, an about longitudinally directed crease forms in the lid at an angle such that, at a location where the crease intersects the hole, a first height of the location depresses further into a volume defined by the pan than a second height of an opposing end of the pan relative to the hole.

11. The litter box of claim 7, wherein the lid is removably attached to a first flange protruding outwardly from the at least one wall at a first end of the pan, and to a second flange protruding outwardly from the at least one wall at a second end of the pan, opposite the first end.

12. The litter box of claim 7, wherein a length of the lid is at least fifty percent greater than a width of the lid.
